(19) United States
(12) Patent Application Publication
(10) Pub. No.: US 2016/0085248 A1
(43) Pub. Date: Mar. 24, 2016

(54) CONDITIONING AN INDOOR ENVIRONMENT

(71) Applicant: Google Inc., Mountain View, CA (US)

(72) Inventors: Robert Samuel Gordon, San Bruno, CA (US); Max Andrew Sills, San Francisco, CA (US)

(21) Appl. No.: 14/491,654

(22) Filed: Sep. 19, 2014

(51) Int. Cl. G05D 23/19

(52) U.S. Cl. CPC G05D 23/1934; G05D 23/1917

(57) ABSTRACT

Techniques for controlling an environmental parameter of an indoor human-occupiable environment include receiving a plurality of values from a plurality of environmental sensors arranged in an indoor human-occupiable environment, the plurality of values associated with at least one environmental parameter of the indoor human-occupiable environment; generating an environmental model of the indoor human-occupiable environment based on the received plurality of values; and using the environmental model to control at least one airflow control device to deliver an airflow to the indoor human-occupiable environment to meet a desired setpoint of the environmental parameter.

### TECHNICAL FIELD

This document relates to systems and methods for conditioning an indoor environment.

### BACKGROUND

Residential, multi-family, and commercial environmental control systems often use a single temperature sensor to control air conditioning and heating equipment that deliver conditioned air to an indoor environment. This often leads to varying degrees of comfort for inhabitants of the indoor environment. For example, depending on a location of particular inhabitant within the indoor environment, the inhabitant's comfort may vary greatly, as the delivered conditioned air may or may not be circulated to that location. Moreover, depending on a location of the temperature sensor within the indoor environment, an efficiency of the air conditioning and heating equipment may not be optimized as considerable energy may be used to condition unoccupied spaces within the indoor environment.

### SUMMARY

In an example implementation, an environmental control system includes a plurality of environmental sensors positionable in an indoor human-occupiable environment; an airflow control device positioned to deliver an airflow to the indoor human-occupiable environment; and a controller communicably coupled to the plurality of environmental sensors and the cooling module. The controller is operable to perform operations including receiving a plurality of values from the plurality of environmental sensors, the plurality of values associated with at least one environmental parameter of the indoor human-occupiable environment; generating an environmental model of the indoor human-occupiable environment based on the received plurality of values; and using the environmental model to control the airflow control device to deliver the airflow to the indoor human-occupiable environment to meet a desired setpoint of the environmental parameter.

In a first aspect combinable with the general implementation, the plurality of values include a plurality of temperature values of the indoor human-occupiable environment, and the environmental model includes a temperature model or a temperature differential model of the indoor human-occupiable environment.

In a second aspect combinable with any of the previous aspects, the controller is further operable to perform operations including generating a geometric model that defines one or more rooms of the indoor human-occupiable environment based on the received plurality of values; and using the environmental model and the geometric model to control the airflow control device to deliver the airflow to the indoor human-occupiable environment to meet the desired setpoint of the environmental parameter.

In a third aspect combinable with any of the previous aspects, the plurality of environmental sensors include a plurality of occupancy sensors positionable in the one or more rooms of the indoor human-occupiable environment.

In a fourth aspect combinable with any of the previous aspects, the controller is further operable to perform operations including determining an occupancy state of at least one of the one or more rooms of the indoor human-occupiable environment; and controlling the airflow control device, based at least in part on the determined occupancy state, to deliver the airflow to the indoor human-occupiable environment to meet the desired setpoint of the environmental parameter.

In a fifth aspect combinable with any of the previous aspects, the airflow control device includes a first airflow control device and the airflow includes a first airflow.

In a sixth aspect combinable with any of the previous aspects, the system further includes a second airflow control device positioned to deliver a second airflow to the indoor human-occupiable environment.

In a seventh aspect combinable with any of the previous aspects, the each of the first and second airflow control devices includes a fan or an airflow damper:

In an eighth aspect combinable with any of the previous aspects, the controller is further operable to perform operations including identifying an adjusted setpoint of the environmental parameter; selecting, based on the environmental model of the indoor human-occupiable environment, at least one of the first or second airflow control devices; and controlling the selected first or second airflow control device to deliver the first or second airflow to the indoor human-occupiable environment to meet the adjusted setpoint of the environmental parameter.

In a ninth aspect combinable with any of the previous aspects, identifying an adjusted setpoint of the environmental parameter includes receiving, through the controller, the adjusted setpoint from a human occupant of the indoor human-occupiable environment.

In a tenth aspect combinable with any of the previous aspects, selecting at least one of the first or second airflow control devices includes predicting, based at least in part on the environmental model, a change to the environmental parameter in a first portion of the indoor human-occupiable environment upon selection of the first airflow control device; predicting, based at least in part on the environmental model, a change to the environmental parameter in the first portion of the indoor human-occupiable environment upon selection of the second airflow control device; determining that the change to the environmental parameter in the first portion of the indoor human-occupiable environment upon selection of the first airflow control device exceeds a threshold of the environmental parameter; and selecting the second airflow control device based on the determined exceeding of the threshold of the environmental parameter.

In an eleventh aspect combinable with any of the previous aspects, the controller is further operable to perform operations including identifying an adjusted setpoint of the environmental parameter; and controlling the first and second airflow control devices to deliver the first and second airflows to the indoor human-occupiable environment to meet the adjusted setpoint of the environmental parameter.

In a twelfth aspect combinable with any of the previous aspects, the controller and at least one of the plurality of environmental sensors are collocated together in the indoor human-occupiable environment.

In another general implementation, a method for controlling an environmental parameter of an indoor human-occupiable environment includes receiving a plurality of values from a plurality of environmental sensors arranged in an indoor human-occupiable environment, the plurality of values associated with at least one environmental parameter of the indoor human-occupiable environment; generating an environmental model of the indoor human-occupiable environment based on the received plurality of values; and using the environmental model to control at least one airflow control device to deliver an airflow to the indoor human-occupiable environment to meet a desired setpoint of the environmental parameter.

In a first aspect combinable with the general implementation, the plurality of values include a plurality of temperature values of the indoor human-occupiable environment, and the environmental model includes a temperature model or a temperature differential model of the indoor human-occupiable environment.

A second aspect combinable with any of the previous aspects further includes generating a geometric model of the indoor human-occupiable environment that defines one or more rooms of the indoor human-occupiable environment; and using the environmental model and the geometric model to control the airflow control device to deliver the airflow to the indoor human-occupiable environment to meet the desired setpoint of the environmental parameter.

In a third aspect combinable with any of the previous aspects, generating a geometric model includes wirelessly receiving location information from the plurality of environmental sensors arranged in the indoor human-occupiable environment; and generating the geometric model of the indoor human-occupiable environment on at least a portion of the location information or the plurality of values.

A fourth aspect combinable with any of the previous aspects further includes determining an occupancy state of at least one of the one or more rooms of the indoor human-occupiable environment with a plurality of occupancy sensors arranged in one or more rooms of the indoor human-occupiable environment; and controlling the airflow control device, based at least in part on the determined occupancy state, to deliver the airflow to the indoor human-occupiable environment to meet the desired setpoint of the environmental parameter.

In a fifth aspect combinable with any of the previous aspects, the at least one airflow control device includes a first airflow control device and a second airflow control device.

A sixth aspect combinable with any of the previous aspects further includes identifying an adjusted setpoint of the environmental parameter; selecting, based on the environmental model of the indoor human-occupiable environment, at least one of the first or second airflow control devices; and controlling the selected first or second airflow control device to deliver the first or second airflow to the indoor human-occupiable environment to meet the adjusted setpoint of the environmental parameter.

In a seventh aspect combinable with any of the previous aspects, identifying an adjusted setpoint of the environmental parameter includes receiving, through the controller, the adjusted setpoint from a human occupant of the indoor human-occupiable environment.

In an eighth aspect combinable with any of the previous aspects, selecting at least one of the first or second airflow control devices includes predicting, based at least in part on the environmental model, a change to the environmental parameter in a first portion of the indoor human-occupiable environment upon selection of the first airflow control device; predicting, based at least in part on the environmental model, a change to the environmental parameter in the first portion of the indoor human-occupiable environment upon selection of the second airflow control device; determining that the change to the environmental parameter in the first portion of the indoor human-occupiable environment upon selection of the first airflow control device exceeds a threshold of the environmental parameter; and selecting the second airflow control device based on the determined exceeding of the threshold of the environmental parameter.

A ninth aspect combinable with any of the previous aspects further includes identifying an adjusted setpoint of the environmental parameter; and controlling the first and second airflow control devices to deliver the first and second airflows to the indoor human-occupiable environment to meet the adjusted setpoint of the environmental parameter.

In a tenth aspect combinable with any of the previous aspects, generating an environmental model of the indoor human-occupiable environment based on the received plurality of values includes transmitting the received plurality of values to a remote network that includes one or more data processing systems; and receiving, from the remote network, the generated environmental model of the indoor human-occupiable environment.

In an eleventh aspect combinable with any of the previous aspects, generating an environmental model of the indoor human-occupiable environment based on the received plurality of values includes identifying a plurality of contextual data associated with the indoor human-occupiable environment; and generating the environmental model of the indoor human-occupiable environment based on the received plurality of values and the plurality of contextual data.

In a twelfth aspect combinable with any of the previous aspects, the plurality of contextual data includes at least one of ambient weather data, time of day data, time of month data, time of year data, or utility usage data.

A thirteenth aspect combinable with any of the previous aspects further includes determining an occupancy status based at least in part on a recognition of one or more particular occupants of the indoor human-occupiable environment; determining a user-specific setpoint of the environmental parameter for each of the one or more particular occupants; and minimizing a variance between the user-specific setpoint for each of the one or more particular occupants while controlling the at least one airflow control device to deliver the airflow to the indoor human-occupiable environment to meet the desired setpoint of the environmental parameter.

In another general implementation, a computer program product encoded on a non-transitory storage medium, the product including non-transitory, computer readable instructions for causing one or more processors to perform operations including receiving a plurality of values from a plurality of environmental sensors arranged in an indoor human-occupiable environment, the plurality of values associated with at least one environmental parameter of the indoor human-occupiable environment; generating an environmental model of the indoor human-occupiable environment based on the received plurality of values; and using the environmental model to control a plurality of airflow control devices to deliver an airflow to the indoor human-occupiable environment to meet a desired setpoint of the environmental parameter.

In a first aspect combinable with the general implementation, the plurality of values include a plurality of temperature values of the indoor human-occupiable environment, and the environmental model includes a temperature model or a temperature differential model of the indoor human-occupiable environment.

A second aspect combinable with any of the previous aspects further includes generating a geometric model of the indoor human-occupiable environment that defines one or more rooms of the indoor human-occupiable environment; and using the environmental model and the geometric model to control the airflow control devices to deliver the airflow to the indoor human-occupiable environment to meet the desired setpoint of the environmental parameter.

A third aspect combinable with any of the previous aspects further includes determining an occupancy state of at least one of the one or more rooms of the indoor human-occupiable environment with a plurality of occupancy sensors arranged in one or more; rooms of the indoor human-occupiable environment; and controlling the airflow control devices, based at least in part on the determined occupancy state, to deliver the airflow to the indoor human-occupiable environment to meet the desired setpoint of the environmental parameter.

A fourth aspect combinable with any of the previous aspects further includes identifying an adjusted setpoint of the environmental parameter; selecting, based on the environmental model of the indoor human-occupiable environment, a particular one of the airflow control devices; and controlling the selected airflow control device to deliver the airflow to the indoor human-occupiable environment to meet the adjusted setpoint of the environmental parameter

Various implementations of an environmental control system according to the present disclosure may include one, some, or all of the following features. For example, the system may more efficiently control (e.g., with less energy used) an HVAC apparatus arranged to condition an indoor environment by generating and using an environmental model of the indoor environment. The generated environmental model can, for instance, predict a temperature, rate of temperature change, and/or airflow, among other environmental characteristics, based on changes to a desired setpoint of the indoor environment, changes to outdoor conditions, and/or changes to an occupancy of the indoor environment. As another example, the environmental model can include or use a geometric or topological model of the indoor environment to predict a temperature, rate of temperature change, and/or airflow model of the indoor environment. As a further example, the system may generate and/or develop multiple environmental models based on, for instance, operational state of the HVAC apparatus (e.g., nighttime operation, daytime operation, vacation operation, and otherwise) and/or operational state of one or more indoor components (e.g., ceiling fans, lights, doors, ventilation and exhaust fans, and otherwise).

The details of one or more embodiments are set forth in the accompanying drawings and the description below. Other features, objects, and advantages will be apparent from the description and drawings, and from the claims.

### DESCRIPTION OF DRAWINGS

FIGS. 1A-1B illustrate schematic side and top views, respectively, of an example implementation of an environmental control system for an indoor human-occupiable environment;

FIG. 2 illustrates an environmental model for the example implementation of the environmental control system for an indoor human-occupiable environment;

FIGS. 3-5 illustrate flowcharts of example methods performed by or with an example implementation of an environmental control system for an indoor human-occupiable environment; and

FIG. 6 is a schematic diagram of a controller that can be used for the operations described in association with any of the computer-implemented methods described herein.

### DETAILED DESCRIPTION

This document discusses example implementations of an environmental control system for an indoor human-occupiable environment. In some implementations, the environmental control system may receive feedback from the indoor environment in the form of sensed values of one or more parameters, such as temperature, humidity, airflow, pressure, energy usage and otherwise. Based on the received values, in some implementations, the environmental control system may develop a digital and/or graphical model of the indoor environment. The model may describe, among other data, the one or more parameters over time. The model may also be predictive of the one or more parameters based on changes that occur to or with the environmental control system, or to or with the indoor environment. The environmental control system may use the model to more efficiently operate (e.g., with less electricity) to meet one or more desired settings, such as temperature, humidity, energy usage, or otherwise.

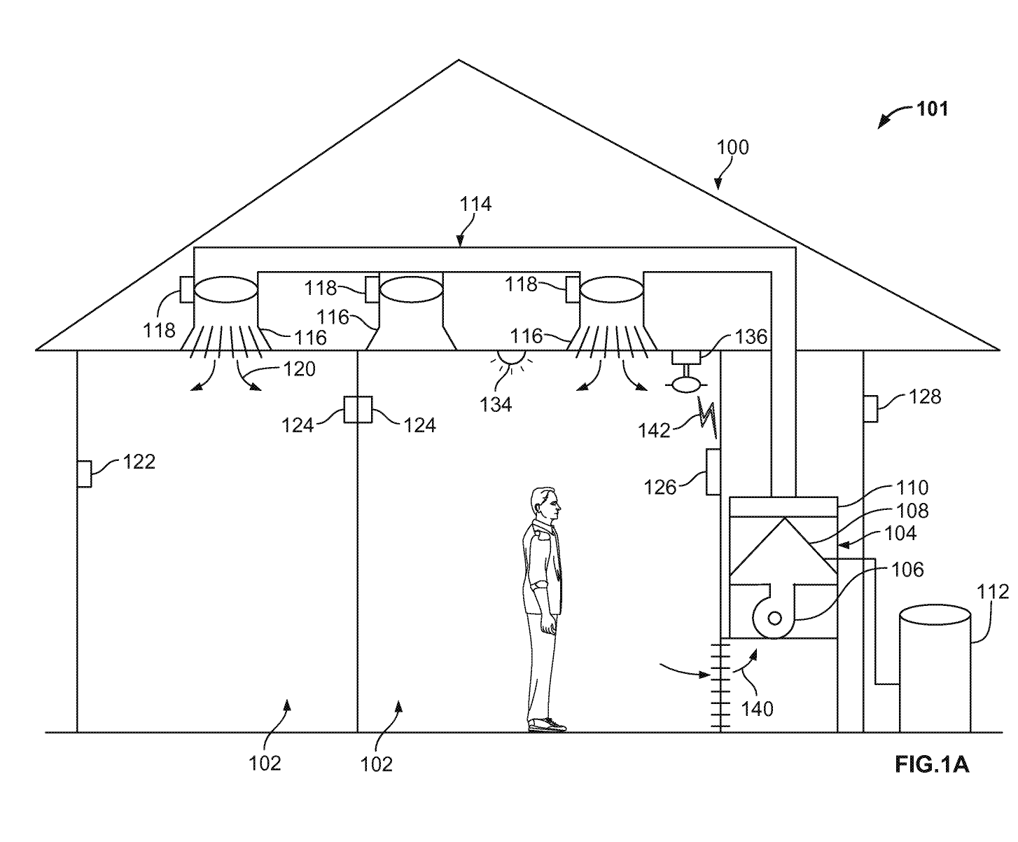

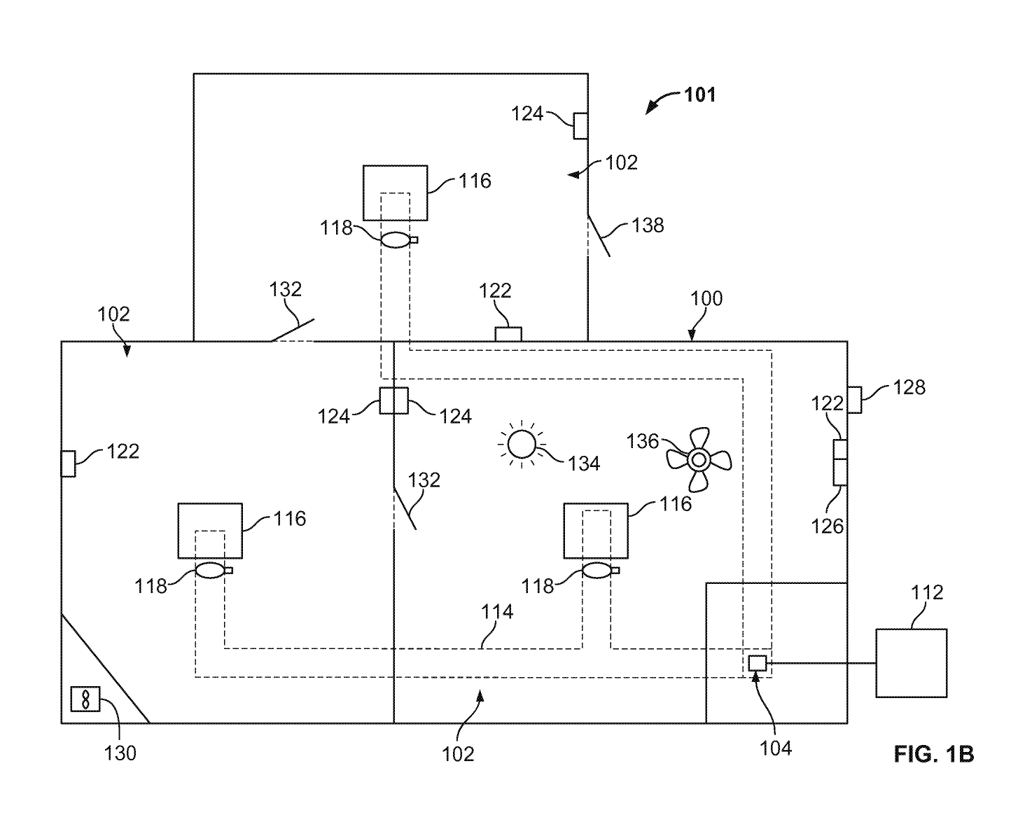

FIGS. 1A-1B illustrate schematic side and top views, respectively, of an example implementation of an environmental control system 101 for an indoor human-occupiable environment 100. Generally, the indoor human-occupiable environment 100 as shown in these figures comprises a residential space, such as a house, townhome, trailer home, mobile home, or otherwise. However, in alternative aspects, the indoor human-occupiable environment 100 may be (and the concepts described herein may be applied to) other spaces, such as apartments, condominiums, multi-family spaces, and commercial or industrial spaces.

Generally, the environmental control system 101 operates to deliver conditioned air to maintain the indoor human-occupiable environment 100 at a particular environmental condition, such as a particular temperature (or temperature range), a particular humidity (or humidity range), a particular temperature/humidity combination, or other environmental condition. In some aspects, the particular environmental condition is set by a user to a desired setpoint or setpoint range. The environmental control system 101, as illustrated, includes an HVAC system comprising an air handling unit 104 (e.g., an indoor unit), a condensing unit 112 (e.g., an outdoor unit), one or more environmental sensors 122, and a thermostat (or controller) 126. Generally, Although these figures illustrate a typical “split system” HVAC system, other HVAC systems are contemplated by the present disclosure as well, such as “packaged” HVAC systems, evaporative cooling HVAC systems (e.g., swamp coolers), and other HVAC systems, whether relying on mechanical refrigeration or not. Indeed, an HVAC system that does not rely on mechanical refrigeration but delivers conditioned air to the indoor human-occupiable environment 100 is contemplated by the present disclosure.

The air handling unit 104 is operable to deliver a supply airflow 120 through a ductwork 114 to condition one or more rooms 102 of the indoor human-occupiable environment 100. The supply airflow 120, in this example, enters the rooms 102 through one or more ceiling mounted grilles 116 in fluid communication with the ductwork system 114. Return airflow 140, which has absorbed heat (e.g., sensible and/or latent) from, or transferred heat to, the air volume in the rooms 102, is circulated back to the air handling unit 104 for conditioning (e.g. cooling, heating, humidifying, dehumidifying).

Although these figures illustrate a typical, overhead air delivery system (e.g., ductwork connected to ceiling grilles), other airflow delivery systems are contemplated by the present disclosure. For example, underfloor air delivery systems (e.g., with ductwork positioned under a raised floor or supply airflow delivered to an open underfloor air plenum) are also contemplated by the present disclosure. Also, ductless systems, whether overhead or underfloor, may be used such that an attic or other space is used as an open supply air plenum to deliver the supply airflow 120 into the rooms 102. Other delivery systems, such as systems in which the supply airflow 102 is delivered from walls (e.g., window units, mini-split systems), floorboard areas (e.g., radiator systems) or otherwise are also within the present disclosure.

The illustrated air handling unit 104 includes a fan 106, a cooling coil 108 that is coupled (e.g., through liquid/vapor refrigerant conduits) to the condensing unit 112, and a heating coil 110 (e.g., water, electric, steam, or otherwise). Although the cooling coil 108 is illustrated as a DX (refrigerant) coil, other types of cooling coils are also within the scope of the present disclosure. For example, one alternative example of the air handling unit 104 includes a heat pump system, in which the coil 108 is both a cooling coil and heating coil (e.g., depending on season). Further, other components of the air handling unit 108, not shown here for simplicity sake, can include filters, humidifiers, dehumidifiers, and other components.

Supply airflow 120 is circulated through the ductwork 114 and, as shown in this example, may be modulated by airflow dampers 118 (e.g., motorized airflow dampers). Generally, each of the airflow dampers 118 may be adjusted (e.g., by the thermostat 126 or other controller) toward an open position for full supply airflow 120 and/or toward a closed position to block supply airflow 120. Although a 1:1 relationship between airflow dampers 118 and grilles 116 is shown in this example, not all grilles 116 may include an airflow damper 118 positioned nearby. Moreover, the airflow dampers 118 are shown as positioned in “branch” ductwork of the system 114, the dampers 118 (or additional dampers 118) may be mounted in the “trunk” ductwork. Although, generally, each airflow damper 118 may define a particular “zone” of the environmental control system 101, there may be multiple dampers 118 per designated zone (e.g., room 102, part of room 102, or collection of rooms 102), and there may be a single damper 118 that serves multiple rooms 102.

Each of the air handling unit 104 (and more particularly the fan 106) and the airflow dampers 118 may be considered an airflow control device. For example, as an airflow control device, the air handling unit 104 and/or airflow dampers 118 may control, modulate, or otherwise adjust a rate of the supply airflow 120. Further, the air handling unit 104 may, in combination with the condensing unit 112 or otherwise, control a temperature of the supply airflow 120. Thus, an airflow control device may control a flow rate and/or temperature of the supply airflow 120 from the grilles 116 and/or through the rooms 102.

As illustrated, multiple environmental sensors 122 may be mounted within the rooms 102, e.g., one per room 102, more than one per room 102, or one sensor 122 per multiple rooms 102. Generally, the environmental sensors 122 are communicably coupled (e.g., wired or wirelessly) to the thermostat 126 and provide feedback (e.g., dynamic, real-time, near real-time or otherwise) to the thermostat 126 about one or more environmental parameters in the rooms 102. For example, the environmental sensors 122 may be temperature sensors. As another example, the environmental sensors 122 may be humidity sensors or combined temperature/humidity sensors. As another example, the environmental sensors 122 may be or include pressure sensors (e.g., barometric sensors or strain sensors). As yet another example, the environmental sensors 122 may be or include light sensors (e.g., ambient or otherwise). Of course, each environmental sensors 122 may be a combination of the aforementioned sensors.

As illustrated, multiple occupancy sensors 124 may be mounted within the rooms 102, e.g., one per room 102, more than one per room 102, or one sensor 124 per multiple rooms 102. Generally, the occupancy sensors 124 are communicably coupled (e.g., wired or wirelessly) to the thermostat 126 and provide feedback (e.g., dynamic, real-time, near real-time or otherwise) to the thermostat 126 about an occupancy state (e.g., occupied or not occupied) of the rooms 102. For example, the occupancy sensors 124 may be motion sensors, cameras with occupancy recognition capability, or other form of occupancy sensor.

For example, in some implementations, the occupancy sensors 124 may employ occupancy recognition of particular users within the indoor human-occupiable environment 100 to optimize each user's comfort using a generated environmental model of the environment 100. Individual recognition techniques, such as facial recognition or using wireless (e.g., Bluetooth™) localization with a personal phone, smartwatch, or fitness band, among others, may be used to determine not only whether a user is in a particular room 102, but which user is in the particular room 102. The generated environmental model can be used to minimize each users level of discomfort in the particular room 102.

In some implementations, the environmental sensors 122 and occupancy sensors 124 may be combined such that a single sensor includes the functionality of both the environmental sensors 122 and the occupancy sensors 124. Further, such combined sensors, as well as the environmental sensors 122 and/or occupancy sensors 124, may include location capability (e.g., through GPS or other form). Thus, in some implementations, each sensor (e.g., combination sensor, environmental sensors 122 and/or occupancy sensors 124) may be able to communicate its position within a particular room 102 and within the indoor human-occupiable environment 100 generally, to the thermostat 126 (or other controller).

As shown in FIG. 1B particularly, a particular environmental sensor 122 may be collocated with the thermostat 126. In this particular example, a “collocated” sensor 122 (or sensor 124) and thermostat 126 may include a sensor 122 that is a part of the thermostat 126, a sensor 122 that is within a single container with the thermostat 126, and/or a sensor 122 that is next to or adjacent the thermostat 126.

Additional appurtenances may be arranged in the indoor human-occupiable environment 100 as shown in FIGS. 1A-1B. For example, there may be one or more lights 134 mounted within, or placed within, the rooms 102. Further, there may be one or more ceiling fans 136 mounted within the rooms 102. Particular rooms 102 within the indoor human-occupiable environment 100, such as bathrooms, kitchens, or otherwise, may include exhaust fans 130. Each appurtenance shown in the figures, as well as interior doors 132, exterior doors 138 and other appurtenances (e.g., cooking or heating equipment, bath or other water fixtures, or otherwise) may affect one or more environmental parameters of the indoor human-occupiable environment 100, such as, for example, pressure, airflow, temperature and/or humidity.

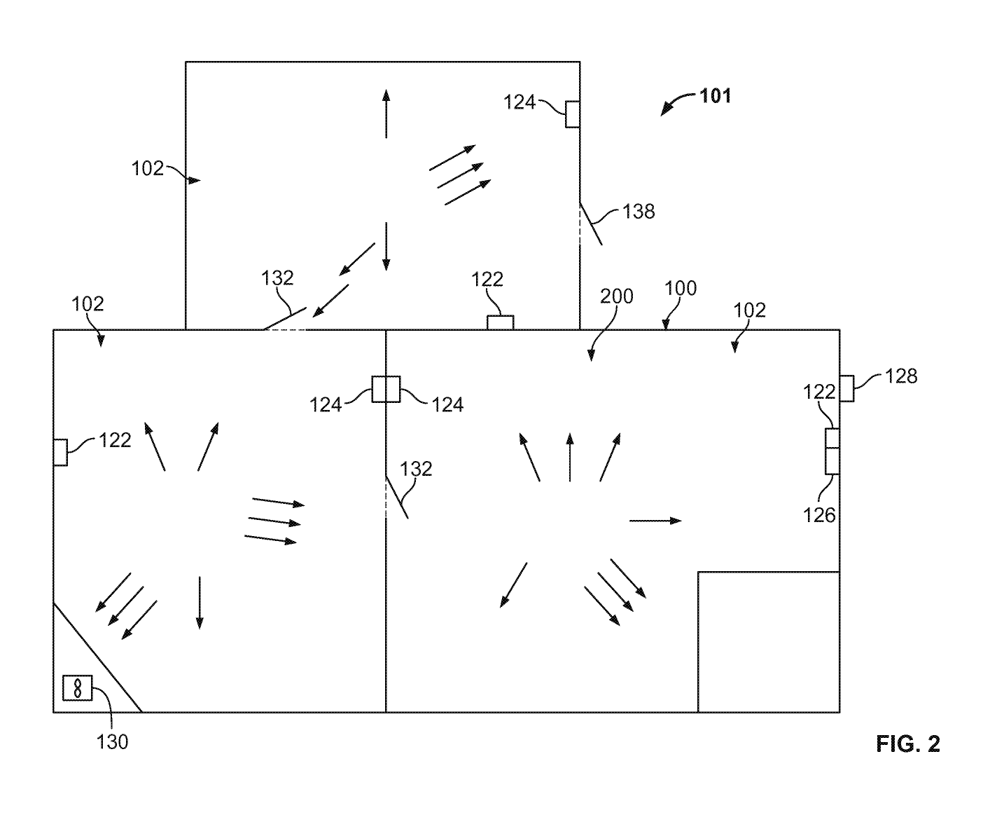

FIG. 2 illustrates an environmental model 200 for the example implementation of the environmental control system 101 for the indoor human-occupiable environment 100. Generally, the environmental model 200, represented in this figure by flowlines, defines one or more environmental parameters of the indoor human-occupiable environment 100 relative to a plurality of locations within the indoor human-occupiable environment 100. The environmental model 200 in this example may represent (graphically or numerically) the one or more environmental parameters of the indoor human-occupiable environment 100 based on operation of the environmental control system 101 to meet a desired setpoint of at least one of the environmental parameters. As one example, a particular environmental parameter may be temperature. A user may provide, either directly, through a pre-arranged schedule, or otherwise, a setpoint temperature (or other parameter, such as humidity, temperature range, or otherwise) to the thermostat 126. The air handling unit 104 operates (with or without the condensing unit 112) to circulate the supply airflow 120 to the rooms 102 to satisfy, or help satisfy, the desired temperature in the rooms 102. In some aspects, one or more airflow dampers 118 may modulate the supply airflow 120 to satisfy, or help satisfy, the desired temperature in the rooms 102. The environmental sensors 122 may measure the temperature in the rooms 102 and report the measured temperatures to the thermostat 126. The thermostat 126 (or control system communicably coupled to the thermostat 126) generates (and possibly stores) the environmental model 200 based on the reported temperatures at known locations (e.g., locations of the environmental sensors 122) within the rooms 102. Thus, in one example, the environmental model 200 may comprise temperature data at known locations during operation of the environmental control system 101, at a particular instant, over a time period, at various intervals, or otherwise (e.g., stored in a data file, graphically, CSV, or other data structure).

As another example, a particular environmental parameter may be temperature differential. The user may provide, either directly, through a pre-arranged schedule, or otherwise, the setpoint temperature (or other parameter, such as humidity, temperature range, or otherwise) to the thermostat 126. The air handling unit 104 operates (with or without the condensing unit 112) to circulate the supply airflow 120 to the rooms 102 to satisfy, or help satisfy, the desired temperature in the rooms 102. In some aspects, one or more airflow dampers 118 may modulate the supply airflow 120 to satisfy, or help satisfy, the desired temperature in the rooms 102. The environmental sensors 122 may measure the temperature in the rooms 102 and report the measured temperatures to the thermostat 126. The thermostat 126 (or control system communicably coupled to the thermostat 126) generates (and possibly stores) the environmental model 200 based on the reported temperatures relative, for example, to previously reported temperatures, at known locations (e.g., locations of the environmental sensors 122) within the rooms 102. Thus, in this example, the environmental model 200 may comprise temperature differential data at known locations during operation of the environmental control system 101, at a particular instant, over a time period, at various intervals, or otherwise (e.g., stored in a data file, graphically, CSV, or other data structure).

As another example, a particular environmental parameter may be airflow. The user may provide, either directly, through a pre-arranged schedule, or otherwise, the setpoint temperature (or other parameter, such as humidity, temperature range, or otherwise) to the thermostat 126. The air handling unit 104 operates (with or without the condensing unit 112) to circulate the supply airflow 120 to the rooms 102 to satisfy, or help satisfy, the desired temperature in the rooms 102. In some aspects, one or more airflow dampers 118 may modulate the supply airflow 120 to satisfy, or help satisfy, the desired temperature in the rooms 102. In this example, the environmental control system 101 may include data regarding the airflow capabilities of the airflow dampers 118 and the air handling unit 104. For example, the environmental control system 101 may have historical data that correlates airflow through the dampers 118 and/or grilles 116 relative to speed of the fan 106, position of the dampers 118, or otherwise. The environmental sensors 122 may measure the temperature in the rooms 102 and report the measured temperatures to the thermostat 126. The thermostat 126 (or control system communicably coupled to the thermostat 126) may determine airflow rate, e.g., at the environmental sensors 122 locations, based on the reported temperature and airflow data. The environmental model 200 may be generated according to the determined airflow rates at known locations during operation of the environmental control system 101, at a particular instant, over a time period, at various intervals, or otherwise (e.g., stored in a data file, graphically, CSV, or other data structure).

Each generated environmental model 200 may include contextual data. For example, contextual data include outdoor environmental conditions (e.g., temperature, humidity, pressure, radiation, and otherwise) as measured, for example, by an outdoor sensor 128, received from remote weather data sources (e.g., Internet, news, or otherwise), and/or determined according to historical weather patterns. For example, each environmental model 200 generated based on similar indoor context (e.g., temperature setpoint, air handling unit operation, and otherwise) may be slightly different because of the outdoor weather context. Contextual data can also include indoor environmental conditions, such as occupancy state, appurtenance operation, and otherwise. Occupancy state (e.g., determined by the occupancy sensors 124) may affect a latent heat load and/or humidity in the indoor human-occupiable environment 100. Appurtenance operation, such as ceiling fan, exhaust fan, door open/closed state, cooking appliance, hot water appliance, may affect temperature, pressure, and/or humidity of the indoor human-occupiable environment 100. By adding contextual data to each generated environmental model 200, or associating each generated environmental model 200 with particular contextual data, each environmental model 200 may present a more accurate snapshot of the environmental conditions in the indoor human-occupiable environment 100 at a particular point in time, which may then be matched to the same or similar conditions at subsequent time instances for optimal operation of the environmental control system 101.

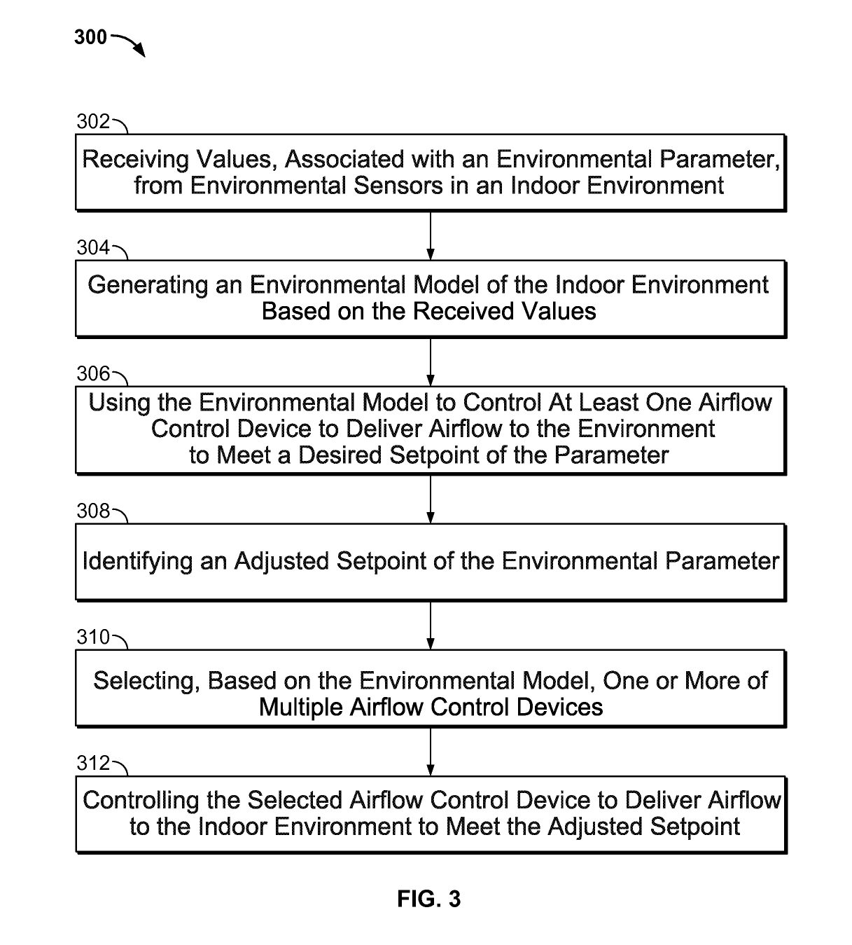

FIGS. 3-5 illustrate flowcharts of example methods performed by or with an example implementation of the environmental control system 101 for the indoor human-occupiable environment 100. For example, method 300 illustrated in FIG. 3 describes one example operation of the environmental control system 101 that uses a generated environmental model 200. Method 300 may begin by receiving values, associated with an environmental parameter, from environmental sensors in an indoor environment at step 302. As described herein, the environmental sensors may receive values associated with a temperature, humidity, temperature differential and/or pressure of the indoor environment, as well as other values. Further, in some implementations, step 302 may include determining an occupancy state of the indoor environment, or a portion of the indoor environment such as one or more rooms, with values received from occupancy sensors arranged in the indoor environment. In some aspects, the values of the environmental parameter and/or occupancy sensors may be received from the same sensors.

Method 300 may continue by generating an environmental model of the indoor environment based on the received values at step 304. In some aspects, as described above, a generated environmental model may include or define a model of a particular environmental parameter, such as temperature, temperature differential, airflow, or otherwise as measured by the environmental sensors at a particular instance, over a period of time, and/or at particular time instances during operation of an environmental control system in the indoor environment. For example, the environmental model may comprise a data structure, graphical model, or other form in which the particular environmental parameter is tracked at particular locations within the indoor environment (e.g., at the environmental sensors) and, for example, may provide a predictive model of the environmental parameter for certain operating conditions. The operating conditions, for example, may include contextual data about, e.g., operation of the environmental control system, outdoor conditions, indoor appurtenance operation, and other data.

In some implementations, the environmental model may be pre-generated, e.g., without receiving values associated with the environmental parameter. For example, based on historical data or test data of operation of the environmental control system within the indoor environment (e.g., historical temperatures, airflows, geometric data of the indoor environment, such as a floor plan), the environmental model may be generated prior to operation of the environmental control system, or even construction of the indoor environment.

In some implementations, the environmental model may be generated on location at the indoor environment. For example, the environmental model may be generated at a thermostat or other controller of the environmental control system, or, as another example, a computing device associated with the indoor environment (e.g., home computer, smart phone or tablet of an occupant of the indoor environment, or other device). In some implementations, the environmental model may be generated by a computing system or data processing system remotely located from the indoor environment. The remotely generated environmental model may be transmitted back to the environmental control system at the indoor environment, or may be accessed remotely by the thermostat or other controller (e.g., wirelessly through signals 142 or otherwise).

Method 300 may continue by using the environmental model to control at least one airflow control device to deliver airflow to the environment to meet a desired setpoint of the parameter at step 306. For example, a desired setpoint of a temperature, humidity, temperature range, or other parameter may be provided to the environmental control system (e.g., in real-time through the thermostat or through a pre-arranged schedule). Based on the environmental model and the desired setpoint, the environmental control system may control, for example, a fan of an air handling unit of the environmental control system, one or more airflow control dampers, a condensing unit of the environmental control system, a humidifier of the environmental control system, or other airflow control device that adjusts airflow rate and/or airflow condition (e.g., temperature, moisture content, or otherwise).

In some aspects, the airflow control device may be controlled based on both the environmental model and a geometric model, or just a geometric model, of the indoor environment. For instance, a geometric model may be generated that defines one or more rooms or other defined spaces (e.g., zones) of the indoor environment. For instance, in some aspects, each sensor (e.g., environmental sensors or occupancy sensors) may transmit its position to the thermostat or other controller and the location data is used to generate the geometric model. In some aspects, the geometric model may be predefined, for instance, through known geometric data of the indoor environment such as floor plans. In some aspects, the geometric model may be generated based on receive dimensional and/or photographic data. For example, the received dimensional data may be generated by an electronic measurement device (e.g., laser measurement device or otherwise) and transmitted to the thermostat or other controller to generate the geometric model. As another example, the thermostat or other controller may receive photographic data of the indoor environment (e.g., pictures or videos of interior spaces or rooms of the indoor environment) and generate the geometric model.

In some aspects, other control devices, other than or in addition to the airflow control device, may be controlled based on the environmental model to meet a desired setpoint of the parameter. For example, other fluid control devices, such as a device that controls a flow of cooling liquid/vapor (e.g., refrigerant or otherwise) between an air handling unit and a condensing unit (e.g., a thermal expansion valve or otherwise) may be controlled to vary an airflow temperature from the air handling unit.

In some aspects, using the environmental model to control at least one airflow control device to deliver airflow to the environment to meet a desired setpoint of the parameter includes determining which of one or more occupants of the indoor environment are present at a particular moment (e.g., during step 306). For example, if one or more known occupants are determined to be present within the indoor environment (e.g., by facial recognition techniques, wireless recognition, or otherwise), the environmental control system may control one or more control devices (e.g., airflow control devices or otherwise) to provide optimal comfort for each occupant. For example, using the model and other techniques (e.g., regression techniques) the control system may determine a variance from a user-specific preference (e.g., temperature) that results from the control of the airflow control device to deliver airflow to the environment to meet the desired setpoint. The variances for the occupants may be minimized by adjusting the control and/or the desired setpoint. Thus, each occupant may be kept within a range of his/her user-specific preference when the environmental model is used to control the airflow control device.

Method 300 may continue by identifying an adjusted setpoint of the environmental parameter at step 308. For example, based on a direct input or scheduled change, a temperature setpoint, humidity setpoint, or other setpoint may be adjusted.

Method 300 may continue by selecting, based on the environmental model, one or more of multiple airflow control devices at step 310. For instance, in response to the adjustment, the thermostat may select a particular airflow control device (e.g., airflow damper) among several airflow control devices. In some aspects, the thermostat may select multiple airflow control devices to meet the adjusted setpoint based on the environmental model. As one example, the environmental model may predict that adjustment of the particular airflow control device may allow the environmental control system to meet the adjusted setpoint without adverse consequences, as opposed to adjustment of another of the particular airflow control device, which may allow the environmental control system to meet the adjusted setpoint but with the consequence of overcooling (or undercooling or some other consequence) another portion of the indoor environment.

The thermostat or other controller may make a determination of which airflow control device to select, or how to operate the selected airflow control device, to ensure maximum comfort of multiple occupants of the indoor environment. For example, operation of a particular airflow control device may satisfy the adjusted setpoint in a particular room or rooms of the indoor environment while causing the environmental parameter in another room or rooms to differentiate from the desired setpoint. If the difference exceed an adjusted threshold, the thermostat may control the airflow control device to optimize the environmental parameter in all portions of the indoor environment.

Method 300 may continue by controlling the selected airflow control device to deliver airflow to the indoor environment to meet the adjusted setpoint at step 312. For example, as described above, the selected airflow control device or devices may be operated (e.g., turned on or off, sped up or down, closed or opened) to meet the adjusted setpoint based on the environmental model.

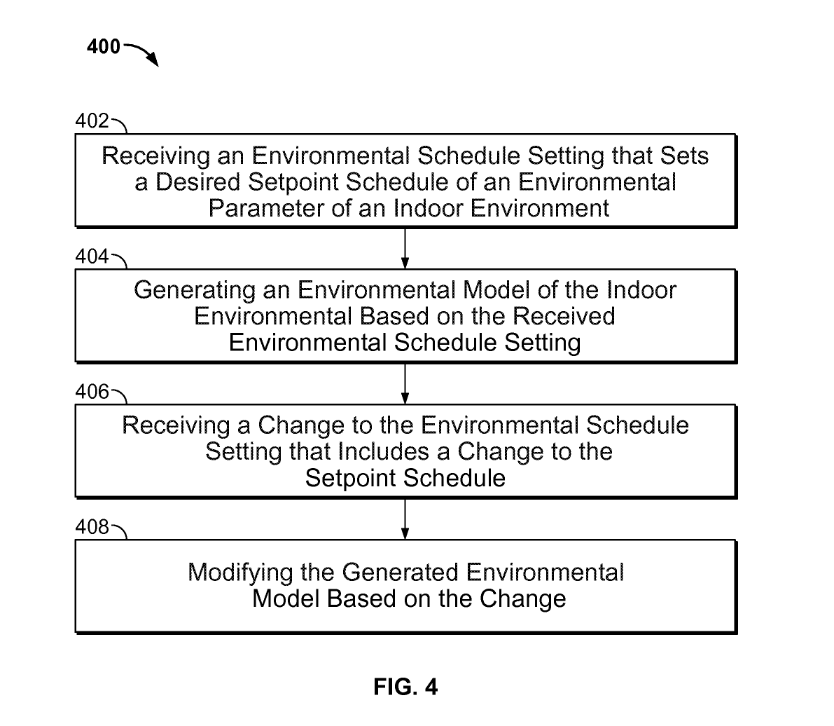

Method 400 illustrated in FIG. 4 may describe one example operation for generating multiple environmental models for an environmental control system of an indoor environment. Method 400 may begin by receiving an environmental schedule setting that sets a desired setpoint schedule of an environmental parameter of an indoor environment at step 402. For example, an environmental schedule setting can be programmed or pre-programmed into a thermostat or other controller of the environmental control system and can include one or multiple time-dependent (e.g., time of day, day of week) setpoints for one or multiple environmental parameters (e.g., temperature, humidity, or otherwise). Example schedules may include a nighttime schedule, a daytime schedule, an unoccupied state schedule (e.g., vacation schedule), an occupied state schedule, as well as others.

Method 400 may continue by generating an environmental model of the indoor environmental based on the received environmental schedule setting at step 404. For example, as the environmental control system operates to meet the one or multiple time-dependent setpoints for one or multiple environmental parameters during a duration of the environmental schedule setting, an environmental model may be generated as described above. In some aspects, the generated environmental model may be associated with the particular environmental schedule setting, as well as contextual data associated with the environmental schedule setting.

Method 400 may continue by receiving a change to the environmental schedule setting that includes a change to the setpoint schedule at step 406. For instance, as described above, there may be multiple environmental schedule settings, which can be adjustably set at the thermostat or other controller. The changed schedule setting may include changes to the one or multiple time-dependent setpoints for one or multiple environmental parameters (e.g., time-dependent changes and/or environmental parameter setpoint changes).

Method 400 may continue by modifying the generated environmental model (or generating a new environmental model) based on the change at step 408. For example, a new environmental model may be generated as the environmental control system operates to meet the one or multiple time-dependent setpoints for one or multiple environmental parameters during a duration of the changed environmental schedule setting as in step 404. Steps 404-408 may be completed many times so that one or more distinct environmental models may be generated for each environmental schedule setting.

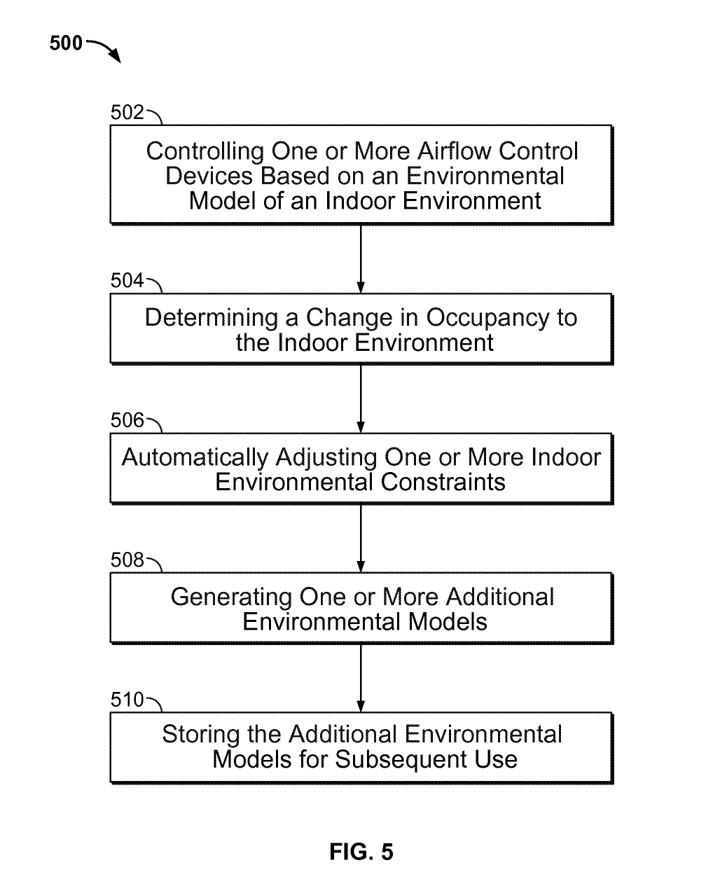

Method 500 illustrated in FIG. 5 may describe another example operation for generating multiple environmental models for an environmental control system of an indoor environment. Method 500 may begin by controlling one or more airflow control devices based on an environmental model of an indoor environment at step 502. For example, during normal operation of an environmental control system, as described in FIG. 3 and herein, the environmental control system may adjust one or more airflow control devices based on a generated environmental model to meet a desired setpoint of an environmental parameter of the indoor environment.

Method 500 may continue by determining an unoccupied state of the indoor environment at step 504. For example, through occupancy sensors (or other techniques), the thermostat or other controller may determine that the indoor environment is in an unoccupied state. This may be done with motion sensors that detect movement over a particular time period, or by a user setting the environmental control system into an unoccupied state.

Method 500 may continue by automatically adjusting one or more indoor environmental constraints at step 506. For instance, because the indoor environment is in the unoccupied state, the thermostat or other controller may determine that a desired setpoint of one or more environmental parameters may be ignored or exceeded even if the adjustment of the one or more indoor environmental constraints may cause the exceeding of the setpoint(s). Because the indoor environment is unoccupied, however, exceeding the setpoint(s) may not cause discomfort for an occupant. The indoor environmental constraints may include components of the environmental control system or appurtenances of the indoor environment that, when operated or adjusted, may cause changes to one or more dynamic or real-time environmental parameters of the indoor environment, such as changes to temperature, humidity, pressure, airflow, or otherwise.

Such components of the environmental control system include, for example, a fan of an air handling unit, a condensing unit, one or more airflow control dampers, energy recovery units, a cooling coil, a heating coil, and/or a humidifier, among other components. Changes to the components of the environmental control system include, for instance, turning on/off a fan of an air handling unit, adjusting a speed of the fan, opening/closing one or more airflow control dampers. Appurtenances of the indoor environment include, for instance, interior doors, exterior doors, ceiling or other cooling fans, exhaust or ventilation fans, plumbing fixtures (e.g., that output hot water), lights, and other components that may affect, through their operation, temperature, humidity, pressure, and/or airflow of the indoor environment. Changes to the appurtenances include, for opening/closing doors, turning on/off ceiling or exhaust fans, turning on/off lights, and other changes.

Method 500 may continue by generating one or more additional environmental models at step 508. For example, as each selected environmental control system component or appurtenance is operated and/or adjusted, the environmental control system may generate a new environmental model, e.g., as described in method 300. In some cases, each component and/or appurtenance is operated serially, and in some cases, two or more components and/or appurtenances are operated in parallel. New environmental models may be generated based on a change to a single component or appurtenance or a change to multiple components or appurtenances. Method 500 may continue by storing the additional environmental models for subsequent use (e.g., during an operation such as method 300) at step 510. Steps 506 through 508 may continue until, e.g., the indoor environment returns to an occupied state.

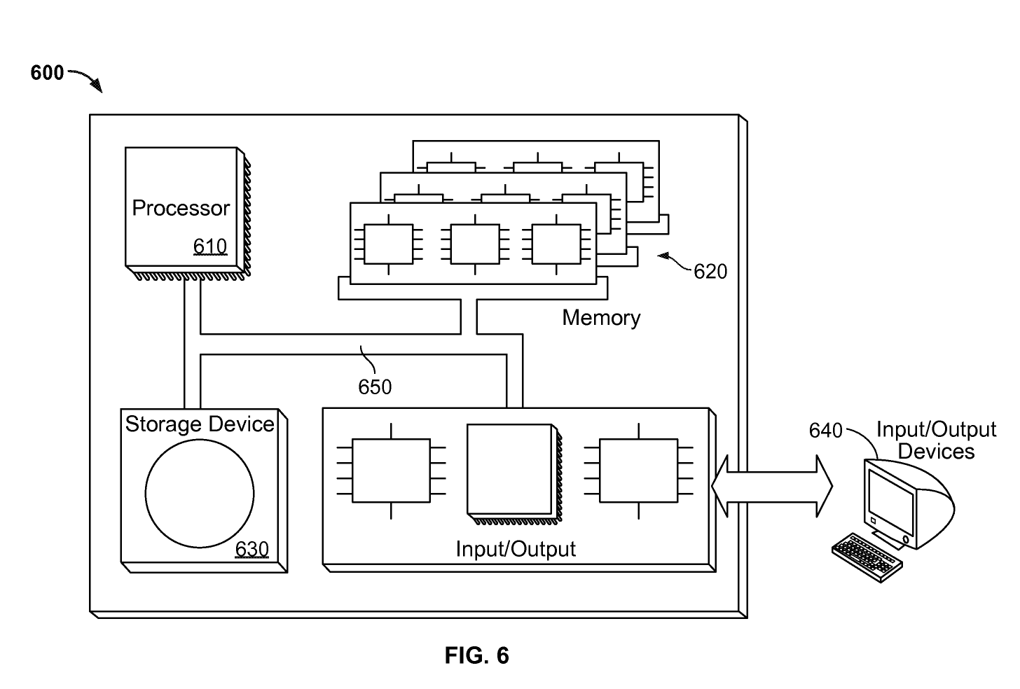

FIG. 6 is a schematic diagram of a controller 600. The controller 600 can be used for the operations described in association with any of the computer-implemented methods described previously, for example as or as part of the thermostat (or controller) 126 or other controllers described herein. For example, the controller 600 may be used in providing local control for one or more airflow control devices, as described above, or in providing master control over an entire indoor human-occupiable environment. Moreover, the controller 600 may describe computing resources that may operate as the loads to be cooled by the systems and methods described above.

The controller 600 is intended to include various forms of digital computers, such as laptops, desktops, workstations, personal digital assistants, servers, blade servers, mainframes, and other appropriate computers. The controller 600 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output device 640. Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the controller 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output device 640 provides input/output operations for the controller 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of embodiments have been described. Nevertheless, it will be understood that various modifications may be made without departing from the spirit and scope of what is described. For example, the steps of the exemplary flow charts in FIGS. 3-5 may be performed in other orders, some steps may be removed, and other steps may be added. Accordingly, other embodiments are within the scope of the following claims.

What is claimed is:

1. An environmental control system, comprising:
a plurality of environmental sensors positionable in an indoor human-occupiable environment;
an airflow control device positioned to deliver an airflow to the indoor human-occupiable environment;
a controller communicably coupled to the plurality of environmental sensors and the cooling module, the controller operable to perform operations comprising:
receiving a plurality of values from the plurality of environmental sensors, the plurality of values associated with at least one environmental parameter of the indoor human-occupiable environment;
generating an environmental model of the indoor human-occupiable environment based on the received plurality of values; and
using the environmental model to control the airflow control device to deliver the airflow to the indoor human-occupiable environment to meet a desired setpoint of the environmental parameter.

2. The environmental control system of claim 1, wherein the plurality of values comprise a plurality of temperature values of the indoor human-occupiable environment, and the environmental model comprises a temperature model or a temperature differential model of the indoor human-occupiable environment.

3. The environmental control system of claim 1, wherein the controller is further operable to perform operations comprising:
generating a geometric model that defines one or more rooms of the indoor human-occupiable environment based on the received plurality of values; and
using the environmental model and the geometric model to control the airflow control device to deliver the airflow to the indoor human-occupiable environment to meet the desired setpoint of the environmental parameter.

4. The environmental control system of claim 3, wherein the plurality of environmental sensors comprise a plurality of occupancy sensors positionable in the one or more rooms of the indoor human-occupiable environment, where the controller is further operable to perform operations comprising:
determining an occupancy state of at least one of the one or more rooms of the indoor human-occupiable environment; and
controlling the airflow control device, based at least in part on the determined occupancy state, to deliver the airflow to the indoor human-occupiable environment to meet the desired setpoint of the environmental parameter.

5. The environmental control system of claim 1, wherein the airflow control device comprises a first airflow control device and the airflow comprises a first airflow, and the system further comprises:
a second airflow control device positioned to deliver a second airflow to the indoor human-occupiable environment.

6. The environmental control system of claim 5, wherein the each of the first and second airflow control devices comprises a fan or an airflow damper:

7. The environmental control system of claim 5, wherein the controller is further operable to perform operations comprising:
identifying an adjusted setpoint of the environmental parameter;
selecting, based on the environmental model of the indoor human-occupiable environment, at least one of the first or second airflow control devices; and
controlling the selected first or second airflow control device to deliver the first or second airflow to the indoor human-occupiable environment to meet the adjusted setpoint of the environmental parameter.

8. The environmental control system of claim 7, wherein identifying an adjusted setpoint of the environmental parameter comprises receiving, through the controller, the adjusted setpoint from a human occupant of the indoor human-occupiable environment.

9. The environmental control system of claim 7, wherein selecting at least one of the first or second airflow control devices comprises:
predicting, based at least in part on the environmental model, a change to the environmental parameter in a first portion of the indoor human-occupiable environment upon selection of the first airflow control device;
predicting, based at least in part on the environmental model, a change to the environmental parameter in the first portion of the indoor human-occupiable environment upon selection of the second airflow control device;
determining that the change to the environmental parameter in the first portion of the indoor human-occupiable environment upon selection of the first airflow control device exceeds a threshold of the environmental parameter; and
selecting the second airflow control device based on the determined exceeding of the threshold of the environmental parameter.

10. The environmental control system of claim 5, wherein the controller is further operable to perform operations comprising:
identifying an adjusted setpoint of the environmental parameter; and
controlling the first and second airflow control devices to deliver the first and second airflows to the indoor human-occupiable environment to meet the adjusted setpoint of the environmental parameter.

11. The environmental control system of claim 1, wherein the controller and at least one of the plurality of environmental sensors are collocated together in the indoor human-occupiable environment.

12. A method for controlling an environmental parameter of an indoor human-occupiable environment, comprising:
receiving a plurality of values from a plurality of environmental sensors arranged in an indoor human-occupiable environment, the plurality of values associated with at least one environmental parameter of the indoor human-occupiable environment;
generating an environmental model of the indoor human-occupiable environment based on the received plurality of values; and
using the environmental model to control at least one airflow control device to deliver an airflow to the indoor human-occupiable environment to meet a desired setpoint of the environmental parameter.

13. The method of claim 12, wherein the plurality of values comprise a plurality of temperature values of the indoor human-occupiable environment, and the environmental model comprises a temperature model or a temperature differential model of the indoor human-occupiable environment.

14. The method of claim 12, further comprising:
generating a geometric model of the indoor human-occupiable environment that defines one or more rooms of the indoor human-occupiable environment; and
using the environmental model and the geometric model to control the airflow control device to deliver the airflow to the indoor human-occupiable environment to meet the desired setpoint of the environmental parameter.

15. The method of claim 14, wherein generating a geometric model comprises:
wirelessly receiving location information from the plurality of environmental sensors arranged in the indoor human-occupiable environment; and
generating the geometric model of the indoor human-occupiable environment on at least a portion of the location information or the plurality of values.

16. The method of claim 14, further comprising:
determining an occupancy state of at least one of the one or more rooms of the indoor human-occupiable environment with a plurality of occupancy sensors arranged in one or more rooms of the indoor human-occupiable environment; and
controlling the airflow control device, based at least in part on the determined occupancy state, to deliver the airflow to the indoor human-occupiable environment to meet the desired setpoint of the environmental parameter.

17. The method of claim 12, wherein the at least one airflow control device comprises a first airflow control device and a second airflow control device.

18. The method of claim 17, further comprising:
identifying an adjusted setpoint of the environmental parameter;
selecting, based on the environmental model of the indoor human-occupiable environment, at least one of the first or second airflow control devices; and
controlling the selected first or second airflow control device to deliver the first or second airflow to the indoor human-occupiable environment to meet the adjusted setpoint of the environmental parameter.

19. The method of claim 18, wherein identifying an adjusted setpoint of the environmental parameter comprises receiving, through the controller, the adjusted setpoint from a human occupant of the indoor human-occupiable environment.

20. The method of claim 18, wherein selecting at least one of the first or second airflow control devices comprises:
predicting, based at least in part on the environmental model, a change to the environmental parameter in a first portion of the indoor human-occupiable environment upon selection of the first airflow control device;
predicting, based at least in part on the environmental model, a change to the environmental parameter in the first portion of the indoor human-occupiable environment upon selection of the second airflow control device;
determining that the change to the environmental parameter in the first portion of the indoor human-occupiable environment upon selection of the first airflow control device exceeds a threshold of the environmental parameter; and
selecting the second airflow control device based on the determined exceeding of the threshold of the environmental parameter.

21. The method of claim 17, further comprising:
identifying an adjusted setpoint of the environmental parameter; and
controlling the first and second airflow control devices to deliver the first and second airflows to the indoor human-occupiable environment to meet the adjusted setpoint of the environmental parameter.

22. The method of claim 12, wherein generating an environmental model of the indoor human-occupiable environment based on the received plurality of values comprises:
transmitting the received plurality of values to a remote network that comprises one or more data processing systems; and
receiving, from the remote network, the generated environmental model of the indoor human-occupiable environment.

23. The method of claim 12, wherein generating an environmental model of the indoor human-occupiable environment based on the received plurality of values comprises:
identifying a plurality of contextual data associated with the indoor human-occupiable environment; and
generating the environmental model of the indoor human-occupiable environment based on the received plurality of values and the plurality of contextual data.

24. The method of claim 23, wherein the plurality of contextual data comprises at least one of ambient weather data, time of day data, time of month data, time of year data, or utility usage data.

25. The method of claim 12, further comprising:
determining an occupancy status based at least in part on a recognition of one or more particular occupants of the indoor human-occupiable environment;
determining a user-specific setpoint of the environmental parameter for each of the one or more particular occupants; and
minimizing a variance between the user-specific setpoint for each of the one or more particular occupants while controlling the at least one airflow control device to deliver the airflow to the indoor human-occupiable environment to meet the desired setpoint of the environmental parameter.

26. A computer program product encoded on a non-transitory storage medium, the product comprising non-transitory, computer readable instructions for causing one or more processors to perform operations comprising:
receiving a plurality of values from a plurality of environmental sensors arranged in an indoor human-occupiable environment, the plurality of values associated with at least one environmental parameter of the indoor human-occupiable environment;
generating an environmental model of the indoor human-occupiable environment based on the received plurality of values; and
using the environmental model to control a plurality of airflow control devices to deliver an airflow to the indoor human-occupiable environment to meet a desired setpoint of the environmental parameter.

27. The computer program product of claim 26, wherein the plurality of values comprise a plurality of temperature values of the indoor human-occupiable environment, and the environmental model comprises a temperature model or a temperature differential model of the indoor human-occupiable environment.

28. The computer program product of claim 26, wherein the operations further comprise:
generating a geometric model of the indoor human-occupiable environment that defines one or more rooms of the indoor human-occupiable environment; and
using the environmental model and the geometric model to control the airflow control devices to deliver the airflow to the indoor human-occupiable environment to meet the desired setpoint of the environmental parameter.

29. The computer program product of claim 28, wherein the operations further comprise:
determining an occupancy state of at least one of the one or more rooms of the indoor human-occupiable environment with a plurality of occupancy sensors arranged in one or more;
rooms of the indoor human-occupiable environment; and
controlling the airflow control devices, based at least in part on the determined occupancy state, to deliver the airflow to the indoor human-occupiable environment to meet the desired setpoint of the environmental parameter.

30. The computer program product of claim 26, wherein the operations further comprise:
identifying an adjusted setpoint of the environmental parameter;
selecting, based on the environmental model of the indoor human-occupiable environment, a particular one of the airflow control devices; and
controlling the selected airflow control device to deliver the airflow to the indoor human-occupiable environment to meet the adjusted setpoint of the environmental parameter.
